(19) United States
(12) Patent Application Publication
(10) Pub. No.: US 2025/0358828 A1
(43) Pub. Date: Nov. 20, 2025

(54) DOWNLINK CONTROL INFORMATION

(71) Applicant: Nokia Technologies Oy, Espoo (FI)

(72) Inventors: Ethiraj ALWAR, Bangalore (IN); Raghuram Reddy KRISHNAMURTHY, Bangalore (IN)

(21) Appl. No.: 19/118,575

(22) PCT Filed: Sep. 4, 2023
(86) PCT No.: PCT/EP2023/074141

§ 371 Date: Apr. 4, 2025

(30) Foreign Application Priority Data
Oct. 10, 2022 (GB) 2214887.8

(51) Int. Cl. H04W 72/231; H04W 72/0457; H04W 76/28

(52) U.S. Cl. CPC H04W 72/231; H04W 72/0457; H04W 76/28

(57) ABSTRACT

An apparatus, comprising: at least one processor; and at least one memory storing instructions that when executed by the at least one processor cause the apparatus at least to perform: transmitting Downlink Control Information to a user equipment, said Downlink Control Information having a control command for said user equipment together with an indication that additional information related to said control command is to be transmitted over a Downlink Shared Channel; and transmitting said additional information related to said control command over said Downlink Shared Channel.

### TECHNOLOGICAL FIELD

Various example embodiments relate to transmitting downlink control information to a user equipment in a wireless telecommunications network.

### BACKGROUND

5G Networks already have a mechanism to control the user equipment (UE) using multiple mechanisms such as a Downlink Control Information (DCI) Command, a Medium Access Control (MAC) Control Element and Radio Resource Control (RRC) Protocol procedures. Although these commands can be used to control the UE, unexpected consequences can occur such as limited functionality in the DCI/MAC CE and a proliferation of signaling in RRC procedures. Accordingly, it is desired to provide an improved technique for controlling user equipment.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided an apparatus, comprising: at least one processor; and
at least one memory storing instructions that when executed by the at least one processor cause the apparatus at least to perform: transmitting Downlink Control Information to a user equipment, the Downlink Control Information having a control command for the user equipment together with an indication that additional information related to the control command is to be transmitted over a Downlink Shared Channel; and transmitting the additional information related to the control command over the Downlink Shared Channel.

The control command may indicate a change in configuration of the user equipment.

The control command may indicate a change in configuration of a radio interface of the user equipment.

The control command may indicate a change in resource configuration of the radio interface of the user equipment.

The control command may indicate a change in Bandwidth Part, Physical Resource Blocks, transmission power, Discontinuous Reception schedule and/or Discontinuous Transmission schedule configuration of the radio interface of the user equipment.

The additional information may indicate additional control parameters related to the control command.

The additional information may indicate at least one quantity related to the change in configuration.

The additional information may indicate an increase, a decrease, an amount of change, a delay period until change and/or a duration of the change in configuration.

The control command or the additional information may indicate that the user equipment should revert to a previous configuration of the user equipment after expiry of the control command.

The Downlink Control Information may be transmitted over a Physical Downlink Control Channel and the additional information may be transmitted using an Information Element over a Physical Downlink Shared Channel.

The control command may indicate which slot the additional information is to be transmitted.

The at least one memory storing instructions that when executed by the at least one processor may cause the apparatus at least to perform: grouping a set of user equipment based on their operation; identifying the change in configuration for the set of user equipment; and transmitting the Downlink Control Information and the additional information indicating the change in configuration to the set of user equipment.

The grouping may group the set of user equipment based on services used and/or traffic pattern.

The at least one memory storing instructions that when executed by the at least one processor may cause the apparatus at least to perform: transmitting an indication of the change in configuration to a Central Unit.

The indication of the change in configuration may be transmitted to the Central Unit using F1 Application Protocol signalling.

The apparatus may comprise a Distributed Unit.

The Distributed Unit and the Central Unit may comprise disaggregated units of a wireless telecommunications network.

According to various, but not necessarily all, example embodiments of the invention there is provided a method, comprising: transmitting Downlink Control Information to a user equipment, the Downlink Control Information having a control command for the user equipment together with an indication that additional information related to the control command is to be transmitted over a Downlink Shared Channel; and transmitting the additional information related to the control command over the Downlink Shared Channel.

The control command may indicate a change in configuration of the user equipment.

The control command may indicate a change in configuration of a radio interface of the user equipment.

The control command may indicate indicates a change in resource configuration of the radio interface of the user equipment.

The control command may indicate a change in Bandwidth Part, Physical Resource Blocks, transmission power, Discontinuous Reception schedule and/or Discontinuous Transmission schedule configuration of the radio interface of the user equipment.

The additional information may indicate additional control parameters related to the control command.

The additional information may indicate at least one quantity related to the change in configuration.

The additional information may indicate an increase, a decrease, an amount of change, a delay until change and/or a duration of the change in configuration.

The control command or the additional information may indicate that the user equipment should revert to a previous configuration of the user equipment after expiry of the control command.

The Downlink Control Information may be transmitted over a Physical Downlink Control Channel and the additional information may be transmitted using an Information Element over a Physical Downlink Shared Channel.

The control command may indicate which slot the additional information is to be transmitted.

The method may comprise: grouping a set of user equipment based on their operation; identifying the change in configuration for the set of user equipment; and transmitting the Downlink Control Information and the additional information indicating the change in configuration to the set of user equipment.

The grouping may group the set of user equipment based on services used and/or traffic pattern.

The method may comprise: transmitting an indication of the change in configuration to a Central Unit.

The indication of the change in configuration may be transmitted to the Central Unit using F1 Application Protocol signalling.

A non-transitory computer readable medium comprising program instructions stored thereon for performing the method and its optional features set out above.

According to various, but not necessarily all, example embodiments of the invention there is provided an apparatus, comprising: at least one processor; and
at least one memory storing instructions that when executed by the at least one processor cause the apparatus at least to perform: receiving a Downlink Control Information at a user equipment, determining if the Downlink Control Information has a control command for the user equipment together with an indication that additional information related to the control command is to be transmitted over a Downlink Shared Channel and, if so, receiving the additional information related to the control command over the Downlink Shared Channel.

The at least one memory storing instructions that when executed by the at least one processor may cause the apparatus at least to perform: executing the control command in accordance with the additional information.

The control command may indicate a change in configuration of the user equipment.

The control command may indicate a change in configuration of a radio interface of the user equipment.

The control command may indicate a change in resource configuration of the radio interface of the user equipment.

The control command may indicate a change in Bandwidth Part, Physical Resource Blocks, transmission power, Discontinuous Reception schedule and/or Discontinuous Transmission schedule configuration of the radio interface of the user equipment.

The additional information may indicate additional control parameters related to the control command.

The additional information may indicate at least one quantity related to the change in configuration.

The additional information may indicate an increase, a decrease, an amount of change, a delay period until change and/or a duration of the change in configuration.

The control command or the additional information may indicate that the user equipment should revert to a previous configuration of the user equipment after expiry of the control command.

The at least one memory storing instructions that when executed by the at least one processor may cause the apparatus at least to perform: reverting to the previous configuration of the user equipment after expiry of the control command.

The Downlink Control Information may be received over a Physical Downlink Control Channel and the additional information may be received using an Information Element over a Physical Downlink Shared Channel.

The control command may indicate which slot the additional information is to be transmitted.

The apparatus may comprise a user equipment.

The Distributed Unit and the Central Unit may comprise disaggregated units of a wireless telecommunications network.

According to various, but not necessarily all, example embodiments of the invention there is provided a method, comprising: receiving a Downlink Control Information at a user equipment, determining if the Downlink Control Information has a control command for the user equipment together with an indication that additional information related to the control command is to be transmitted over a Downlink Shared Channel and, if so, receiving the additional information related to the control command over the Downlink Shared Channel.

The method may comprise: executing the control command in accordance with the additional information.

The control command may indicate a change in configuration of the user equipment.

The control command may indicate a change in configuration of a radio interface of the user equipment.

The control command may indicate a change in resource configuration of the radio interface of the user equipment.

The control command may indicate a change in Bandwidth Part, Physical Resource Blocks, transmission power, Discontinuous Reception schedule and/or Discontinuous Transmission schedule configuration of the radio interface of the user equipment.

The additional information may indicate additional control parameters related to the control command.

The additional information may indicate at least one quantity related to the change in configuration.

The additional information may indicate an increase, a decrease, an amount of change, a delay period until change and/or a duration of the change in configuration.

The control command or the additional information may indicate that the user equipment should revert to a previous configuration of the user equipment after expiry of the control command.

The method may comprise: reverting to the previous configuration of the user equipment after expiry of the control command.

The Downlink Control Information may be received over a Physical Downlink Control Channel and the additional information may be received using an Information Element over a Physical Downlink Shared Channel.

The control command may indicate which slot the additional information is to be transmitted.

A non-transitory computer readable medium comprising program instructions stored thereon for performing the method and its optional features set out above.

According to various, but not necessarily all, example embodiments of the invention there is provided an apparatus, comprising: at least one processor; and at least one memory storing instructions that when executed by the at least one processor cause the apparatus at least to perform: receiving, from a Distributed Unit, an indication of a change in configuration for a user equipment, the indication being received at a Central Unit using F1 Application Protocol signalling.

The at least one memory storing instructions that when executed by the at least one processor may cause the apparatus at least to perform: storing the change in configuration in a User Equipment Context related to the user equipment.

According to various, but not necessarily all, example embodiments of the invention there is provided a method, comprising: receiving, from a Distributed Unit, an indication of a change in configuration for a user equipment, the indication being received at a Central Unit using F1 Application Protocol signalling.

The method may comprise: storing the change in configuration in a User Equipment Context related to the user equipment.

A non-transitory computer readable medium comprising program instructions stored thereon for performing the method and its optional features set out above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

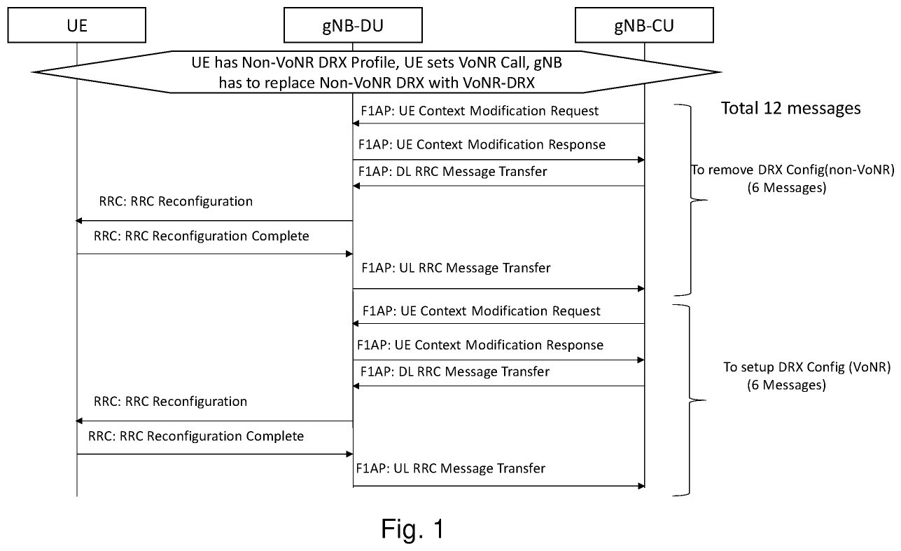

FIG. 1 illustrates messaging between network nodes of a wireless telecommunications network when effecting a configuration change;

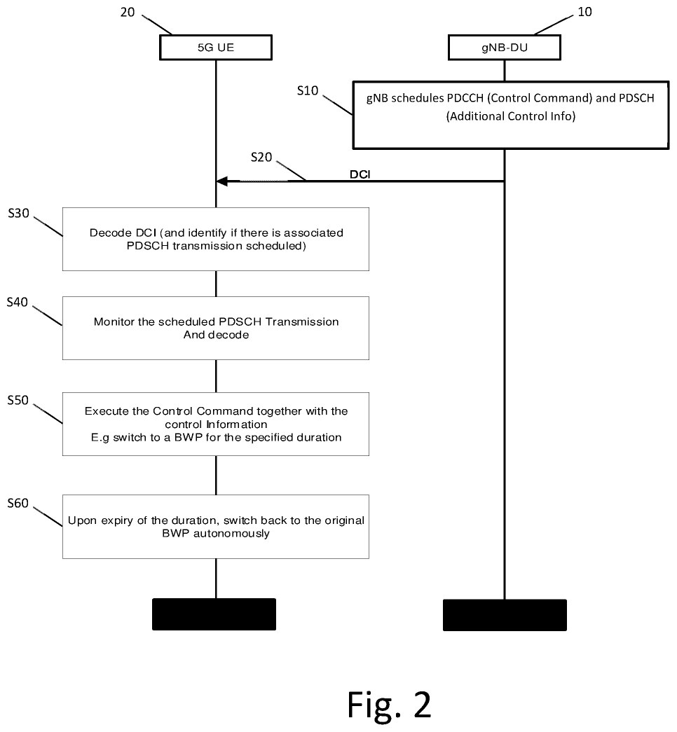

FIG. 2 illustrates steps taken by a Distributed Unit and a User Equipment when effecting a configuration change according to one example embodiment; and

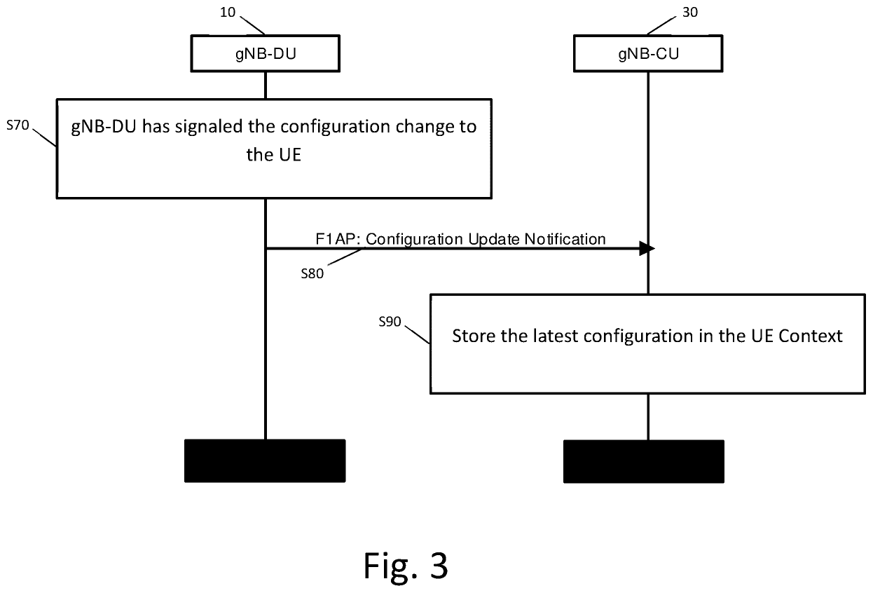

FIG. 3 illustrates steps taken by a Distributed Unit and a Central Unit when effecting a configuration change according to one example embodiment.

### DETAILED DESCRIPTION

Before discussing the example embodiments in any more detail, first an overview will be provided. Some example embodiments provide a technique whereby a first network node of a wireless telecommunications network is able to send a command over a first channel to a second network node of a wireless telecommunications network to change their configuration from a first configuration to a second configuration. The command is accompanied by additional information sent over a second channel to the second network node. The second network node then executes the command in accordance with the additional information to change their configuration to the second configuration. The additional information may include conditional information about when or under which conditions the configuration change should happen. The second network node may then revert to first configuration once the conditions no longer apply. For example, the command may require a configuration change to the radio interface and the conditional information may indicate in more detail what that configuration change is and/or when that configuration change should occur. This approach enables more complex configuration changes to be made than would normally be supportable by the command over the first channel through the augmentation of the additional information sent over the second channel. Also, making the configuration change conditional can lead to fewer commands needing to be sent since the configuration can change again without any further command being sent.

By way of background, 5G Networks already have a mechanism to control the user equipment (UE) using multiple mechanisms such as a Downlink Control Information (DCI) Command and a Medium Access Control (MAC) Control Element. However, these commands are executed instantaneously. For example, when a DCI Command to switch a UE to another Bandwidth Part (BWP) is sent, the UE executes it immediately and moves to the indicated BWP. So, the control mechanism can be seen more like a trigger to use a new configuration (new BWP, Uplink (UL) Power or Discontinuous Receive (DRX) Configuration, etc.) from a given moment and that remains valid until a new command is received. With the introduction of Artificial Intelligence and Machine Learning (AIML) support in the Radio Access Network (RAN) and also in the context of 6G which supports diverse use cases, it is then possible for the RAN to predict additional information associated with the control command. For example, when a UE is being switched from BWP1 to BWP2 when there is congestion in BWP1, it is possible for the RAN also to predict when the UE can be switched back to BWP1. In another example, it is possible to optimise the DRX configuration dynamically. If this is done based on a L3-based solution, it introduces more latency. This implies the need to send additional information to the UE associated with the control command. Some example embodiments provide a mechanism to enable this. As an example, Connected DRX (CDRX) optimization in a key issue as this has big impact on the UE power consumption (battery life). Also, support of CDRX enhancement for power saving handling is a key issue that is being studied in the context of XR (Extended Reality) services in 3 gpp Rel-18. Hence, CDRX Optimization is a key topic that needs to be addressed.

Hence, it is desirable to provide for faster and more efficient signalling of dynamic controls than provided in existing approaches. The existing signalling and latency involved can be illustrated in the following example use cases: Use case #1 (which is DCI based): Switch BWP 1 to 2 for a given duration. In the existing approach, this requires 2 DCIs, one to switch to BWP 2 and another DCI to switch back to BWP1. Use case #2 (which is RRC based): More dynamic control of DRX Configuration (on-off period or other configuration change). A signalling overhead is introduced due to the set of Setup/Release actions which are involved between the Central Unit (CU)/Distributed Unit (DU) of a 5G disaggregated gNB and Network (NW)/UE.
a) Release current DRX Configuration in DU
b) Release current DRX Configuration in UE
c) Setup updated DRX Configuration in DU
d) Setup updated DRX Configuration in UE

From a signalling perspective, there will be a total of 12 messages involving F1AP and RRC interfaces due to which there is also increased latency, as illustrated in FIG. 1.

Accordingly, some example embodiments provide: a DU-centric approach to identify the need for dynamically control of resource configurations; a DU-centric Physical Downlink Control Chanel+Physical Downlink Shared Chanel (PDCCH+PDSCH) based approach for signalling of associated configuration information; and DU notification of the configuration change to the CU.

### Identification of the Need for Dynamic Control of Resource Reconfiguration in DU

In some example embodiments, the DU performs analysis and groups the UE(s) based on services used/traffic pattern or other operating characteristics (the group may comprise just a single UE). The DU monitors the UL/DL Traffic pattern/Radio Conditions/other operating parameters for those UE(s). The DU identifies (using ML or non-ML techniques) an optimal UE configuration required, such as CDRX Configuration, BWP Switching needed or the like. The DU decides the set of UE(s) for which the CDRX, BWP or other UE configuration has to be reconfigured.

### PDCCH+PDSCH Based Approach for Signalling of Associated Configuration Information in DU

In some example embodiments, the current DCI based signalling is extended to include additional configuration or control information associated with the “control command”. “Control command” here refers to the additional actions for the optimal UE configuration (new BWP configuration, change in Physical Resource Blocks, UL Power configuration, DRX Configuration, Discontinuous Transmit (DTX) Configuration, etc) determined above for the UE(s). Currently, DCI (mapped to PDCCH) can be used to signal only a certain amount of configuration or control information. In some example embodiments, the additional configuration or control information is carried in the PDSCH associated with the control information carried in the DCI mapped to PDCCH. Typically, the DCI provides an indication that the additional configuration or control information is carried in the PDSCH. Typically, the DCI provides an indication of the slot which carries the additional configuration or control information. The additional configuration or control information typically indicates additional control parameters related to the DCI such as an increase, a decrease, an amount of change, a delay period until change and/or a duration of said change in configuration for the optimal UE configuration, as described in more detail below. Such a mechanism enables a fast signalling-based approach to execute/control the needed configuration changes in the UE (such as BWP, UL Power or DRX Configuration, etc) and reduces the latency and power due to the possibility of the dynamic decision making and low signalling overhead.

As mentioned above, the control command and the additional control information can be transmitted in the same slot or in different slots (the DCI triggers the UE to monitor the PDSCH region for the additional control information).

### DU Notification of the Configuration Change to CU

In some example embodiments, the DU notifies the configuration change requested by the DCI and the additional configuration or control information to the CU because the CU keeps track of the current configuration for a given UE.

The approach of some example embodiments provides for effective control/management of latency; power saving gains/battery life improvement

### Example Operation-A Mechanism to Detect the Need for Resource Reconfiguration in DU

First, the DU groups the UE(s) based on services used/traffic pattern. The DU then monitors the UL/DL Traffic pattern/Radio Conditions. The DU Identifies an optimal CDRX Configuration or BWP Switching needed. The DU decide the set of UE(s) for which CDRX or BWP has to be reconfigured.

### Example Operation-A Mechanism to Enhance Control Command With Optional Additional Information, Where in the Additional Information is Carried via the PDSCH Rather Than in the PDCCH

This approach has the additional benefits of PDSCH Link adaption and is more efficient. The DCI provides a mechanism to identify the specific resource that are being controlled e.g. BWP, Power, DRX Duration and the associated additional control information carried on PDSCH e.g. Increase/Decrease, Amount, Duration, etc. That optional additional information Information Element (IE) is provided together with the DCI. If included, UE will restore the previous configuration when the criteria mentioned in the additional information is met

### Example-BWP Switch

As illustrated in FIG. 2, at step S10, the DU 10 determines that BWP1 is congested and gNB-DU decides to move high priority UE(s) 20 to BWP2 for a certain duration (predicted) after which the high priority UE(s) 20 can autonomously return to the BWP1. UE 20 is currently in BWP1.

At step S20, a DCI command is issued to switch to BWP 2 with Additional Information=timer value 5s (derived based on AIML algorithm).

At step S30, the UE 20 decodes the DCI and identifies that Additional Information is included in PDSCH.

At step S40, the UE 20 monitors PDSCH and decodes the Additional Information.

At step S50, the UE 20 executes the DCI command together with the Additional Information (switch to BWP 2 for a 5s duration).

At step S60, when the 5s duration expires, the UE switches back to BWP1.

### Example-CDRX Reconfiguration

In a similar manner to step S10 mentioned above, the DU 10 determines a change in DRX schedule is required.

In a similar manner to step S20 mentioned above, a DCI command is issued together with Additional Information. Such a DCI command together with Additional Information may include:
reduce/increase DRX On-duration by X amount for T period;
reduce/increase DRX DRX-Inactivity-duration for T period

Similarly, the DCI command together with Additional Information can be applied to all parameters to C-DRX.

In a similar manner to steps S30 to S60 mentioned above, the UE 20 decodes the DCI and identifies that Additional Information is included in PDSCH, the UE 20 monitors PDSCH and decodes the Additional Information. The UE 20 executes the DCI command together with the Additional Information. When the duration expires, the UE switches back to the previous configuration without the need for an additional command.

### Example Operation-Notification Method from DU to CU

In some example embodiments, since the DU 10 is using the dynamic control mechanism to execute the configuration changes of certain resources (BWP Switching, DRX Configuration, etc.), the DU 10 should also be able to signal the latest configuration to the CU 30.

As illustrated in FIG. 3, at step S70, the DU 10 determines that the configuration change has been signalled to the UE 20.

At step S80, the DU 10 signals the configuration change to the CU 30.

At step S90, the CU 30 stores the latest configuration in the UE Context.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware.

The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1.-10. (canceled)

11. A user equipment comprising:
at least one processor; and
at least one memory storing instructions that when executed by the at least one processor cause the user equipment at least to perform:
decoding Downlink Control Information on Physical Downlink Control Channel, wherein the Downlink Control Information has a control command for the user equipment together with an indication that additional information related to the control command is carried over Physical Downlink Shared Channel, wherein the control command indicates a change in configuration and the additional information indicates additional control parameters related to the control command comprising a duration of the change in configuration, wherein the control command indicates a change in Bandwidth Part, Physical Resource Blocks, transmission power, Discontinuous Reception schedule and Discontinuous Transmission schedule configuration of the radio interface of the user equipment, and wherein the control command further indicates switching to a second bandwidth part and after the expiry, carrying out an autonomous return to the bandwidth part of the previous configuration;
monitoring the Physical Downlink Shared Channel;
decoding the additional information;
executing the control command in accordance with the additional information; and
reverting to the previous configuration of the user equipment after expiry of the duration.

12. The user equipment of claim 11, wherein the additional information further indicates increase, decrease, an amount of the change and a delay period until the change.

13. The user equipment of claim 12, wherein the control command further indicates reducing and increasing Discontinuous Reception On-duration by a certain amount, or
reducing and increasing Discontinuous Reception Inactivity-duration by a certain amount, and
after the expiry, carrying out an autonomous return to the previous configuration.

14. A system comprising:
a user equipment;
at least one processor; and
at least one memory storing instructions that when executed by the at least one processor cause the user equipment at least to perform:
decoding Downlink Control Information on Physical Downlink Control Channel, wherein the Downlink Control Information has a control command for the user equipment together with an indication that additional information related to the control command is carried over Physical Downlink Shared Channel, wherein the control command indicates a change in configuration and the additional information indicates additional control parameters related to the control command comprising a duration of the change in configuration, wherein the control command indicates a change in Bandwidth Part, Physical Resource Blocks, transmission power, Discontinuous Reception schedule and Discontinuous Transmission schedule configuration of the radio interface of the user equipment, and wherein the control command further indicates switching to a second bandwidth part and after the expiry, carrying out an autonomous return to the bandwidth part of the previous configuration;
monitoring the Physical Downlink Shared Channel;
decoding the additional information;
executing the control command in accordance with the additional information; and
reverting to the previous configuration of the user equipment after expiry of the duration.

15. The system of claim 14, wherein the additional information further indicates increase, decrease, an amount of the change and a delay period until the change.

16. The system of claim 15, wherein the control command further indicates reducing and increasing Discontinuous Reception On-duration by a certain amount, or
reducing and increasing Discontinuous Reception Inactivity-duration by a certain amount, and
after the expiry, carrying out an autonomous return to the previous configuration.

17. A method comprising:
decoding, by a user equipment, Downlink Control Information on Physical Downlink Control Channel, wherein the Downlink Control Information has a control command for the user equipment together with an indication that additional information related to the control command is carried over Physical Downlink Shared Channel, wherein the control command indicates a change in configuration and the additional information indicates additional control parameters related to the control command comprising a duration of the change in configuration, wherein the control command indicates a change in Bandwidth Part, Physical Resource Blocks, transmission power, Discontinuous Reception schedule and Discontinuous Transmission schedule configuration of the radio interface of the user equipment, and wherein the control command further indicates switching to a second bandwidth part and after the expiry, carrying out an autonomous return to the bandwidth part of the previous configuration;
monitoring, by the user equipment, the Physical Downlink Shared Channel;
decoding, by the user equipment, the additional information;
executing, by the user equipment, the control command in accordance with the additional information; and
reverting, by the user equipment, to the previous configuration of the user equipment after expiry of the duration.

18. The method of claim 17, wherein the additional information further indicates increase, decrease, an amount of the change and a delay period until the change.

19. The method of claim 18, wherein the control command further indicates reducing and increasing Discontinuous Reception On-duration by a certain amount, or
reducing and increasing Discontinuous Reception Inactivity-duration by a certain amount, and
after the expiry, carrying out an autonomous return to the previous configuration.
